(19) United States
(12) Patent Application Publication
(10) Pub. No.: US 2009/0296411 A1
(43) Pub. Date: Dec. 3, 2009

(54) ILLUMINATING DEVICE AND HEAT-DISSIPATING STRUCTURE THEREOF

(75) Inventors: Sean Chang, Taoyuan Hsien (TW); Kuo-Chiang Tu, Taoyuan Hsien (TW); Li-Tang Chang, Taoyuan Hsien (TW)

Correspondence Address: Muncy, Geissler, Olds & Lowe, PLLC, P.O. BOX 1364, FAIRFAX, VA, 22038-1364, US

(73) Assignee: Delta Electronics Inc.

(21) Appl. No.: 12/182,564

(22) Filed: Jul. 30, 2008

(30) Foreign Application Priority Data
May 28, 2008 (TW) 097119648

(51) Int. Cl. F21V 29/00; F28F 13/00

(52) U.S. Cl. 362/373; 165/185

(57) ABSTRACT

The present invention provides an illuminating device and heat-dissipating structure thereof. The heat-dissipating structure includes at least one thermally conductive element and a plurality of heat-dissipating units stacked together. Each heat-dissipating unit includes a cone-like fin with an opening and a plurality of protrusions connected to the cone-like fin, wherein at least one of the protrusions of one heat-dissipating unit is coupled to that of the adjacent heat-dissipating unit to form one or more zonal planes for allowing one end of the thermally conductive element to be disposed thereon, and the other end of the thermally conductive element is connected with a heat source to constitute the illuminating device.

### CROSS REFERENCE TO RELATED APPLICATIONS

This Non-provisional application claims priority under 35 U.S.C §119(a) on Patent Application No(s). 097119648 filed in Taiwan, Republic of China on May 28, 2008, the entire contents of which are hereby incorporated by reference.

### BACKGROUND OF THE INVENTION

1. Field of Invention

The present invention relates to an illuminating device and a heat-dissipating structure thereof, and in particular, to an illuminating device combining a cone-like heat-dissipating structure with thermal conductive elements.

2. Related Art

Traditionally, heat sinks are made by aluminum extrusion, metal die casting or metal forging. However, such a manufacturing way has the disadvantages of high cost, overweight, complicated process, large volume, bad efficiency of natural convection, etc. Due to the above problems, another way is to utilize mechanical press to make several fins for being stacked together to constitute a heat sink. However most of heat sinks are formed by stacked planar fins and such a design will be limited by its shape, so that the direction of the airflow will be limited to a direction in parallel to the stacked direction of fins. Moreover, this kind of heat sink can not attain the purpose of multi-directional natural convection for heat dissipation.

### SUMMARY OF THE INVENTION

In view of the foregoing, the invention is to provide an illuminating device and a heat-dissipating structure thereof.

To achieve the above, the present invention discloses a heat-dissipating structure including at least one thermal conductive element and a plurality of heat-dissipating units. Each heat-dissipating unit includes a cone-like portion with an opening and a plurality of protrusions connected to the cone-like portion, wherein at least one of the protrusions of one heat-dissipating unit is coupled to that of the adjacent heat-dissipating unit to form one or more zonal planes for allowing one end of the thermal conductive element to be disposed thereon, and the openings of the heat-dissipating units are linked together to form an airflow passage.

A heat source is disposed on the thermal conductive element directly, or is connected with the thermal conductive element via a carrier having a plane for allowing the heat source to be disposed thereon. The cross section of the thermal conductive element is a square, a circle, an ellipse or a rectangle, and the thermal conductive element is a hollow or non-hollow structure. The thermal conductive element is preferably a thermal conductive pipe or a thermal conductive bar. The thermal conductive elements and the carrier are made of a metallic or non-metallic high thermal conductive material.

The heat-dissipating units are stacked together to constitute an multilayer structure with a protruding end and a concave end, and the heat source is disposed coordinating with the thermal conductive element at the protruding end or the concave end. The heat-dissipating structure further comprises a fan disposed opposite to the heat source at the one end of the multilayer structure, and guiding the airflow to the heat source via the airflow passage formed by the openings of the heat-dissipating units.

The heat-dissipating unit is formed by metal stamping. Preferably, the heat-dissipating unit is a pyramid, a conoid or an umbrella-shaped unsymmetrical structure.

Optionally, the protrusion has a fastener for positioning and connecting with the adjacent protrusion and a through hole for accelerating movement of the airflow. The protrusion has preferably a planar or stepped bending portion. The plurality of protrusions are symmetrically or unsymmetrically disposed on the edge of the cone-like portion.

The surface of the heat-dissipating unit is processed physically or chemically for accelerating heat-radiation, for example but not limited to, the anodic treatment or the heat-radiating material coating. The surface of the heat-dissipating unit may also have a microstructure.

The heat-dissipating unit further includes a plurality of apertures. The cone-like portion is formed by a plurality of fins or a single annular fin.

Preferably, the heat source is a light emitting diode (LED), a laser diode, an organic light emitting diode (OLED) or a semiconductor light source.

To achieve the above, an illuminating device of the present invention comprises a thermal conductive element, an multilayer structure, a heat source. The multilayer structure including a plurality of heat-dissipating units stacked together. Each heat-dissipating unit includes a cone-like portion with an opening and a plurality of protrusions connected to the cone-like portion. The thermal conductive element is disposed on a plane formed by the protrusions. The heat source is connected with the thermal conductive element.

Wherein the heat source is disposed on the thermal conductive element directly, or is connected with the thermal conductive element via a carrier having a plane for allowing the heat source to be disposed thereon. The multilayer structure has a protruding end and a concave end, and the heat source is disposed coordinating with the thermal conductive element at the protruding end or the concave end. The illuminating device further comprises a fan disposed opposite to the heat source at the one end of the multilayer structure, and guiding the airflow to the heat source via the airflow passage formed by the openings of the heat-dissipating units.

Wherein the light source is preferably a light emitting diode, a laser diode, an organic light emitting diode, or a semiconductor light source.

The illuminating device further comprises a transparent housing disposed outside the heat-dissipating structure and the light source. The transparent housing has one or more vents optionally.

The illuminating device further comprises a securing structure for fastening the heat-dissipating structure. The securing structure comprises a first part and a second part, and the illuminating device further comprises an electric component disposed in a space formed between the first part and the second part of the securing structure. Of course, the electric component is not needed if the light source is an alternating current LED. The first part has a plurality of through holes optionally.

The illuminating device further comprises a power connector and the type of the power connector is E10/E11, E26/E27, or E39/E40.

### BRIEF DESCRIPTION OF THE DRAWINGS

The present invention is more fully understood by reading the subsequent detailed description and examples with references made to the accompanying drawings, wherein:

FIG. 1A and FIG. 1B are perspective diagrams of different types of the heat-dissipating units of the heat-dissipating structure according to the present invention;

FIG. 2A and FIG. 2B are top views of other types of the heat-dissipating unit of the heat-dissipating structure according to the present invention;

FIG. 3 is a perspective diagram of the heat-dissipating structure formed by assembling a plurality of heat dissipating units as shown in FIG. 1A;

FIG. 4A and FIG. 4B are schematic diagrams showing different stacked types of a plurality of the bending portions of the heat-dissipating structure shown in FIG. 3;

FIG. 5A and FIG. 5B is perspective diagrams showing different assembling types of the heat source and the heat-dissipating structure according to the present invention;

FIG. 6A to FIG. 6D are top views showing different amounts of the thermal conductive elements of the heat-dissipating structure according to the present invention;

FIG. 7 is a perspective diagram of the heat-dissipating structure including a carrier according to the present invention;

FIG. 8A and FIG. 8C are schematic diagrams of the different assembly of the fan, the heat source and the heat-dissipating structure according to the present invention;

FIG. 8B and FIG. 8D are schematic diagrams showing the airflow of the heat-dissipating structure of the present invention as shown in FIG. 8A and FIG. 8C;

FIG. 9A is an exploded view of the illuminating device according to the present invention before being assembled;

FIG. 9B is a perspective diagram of the illuminating device of the present invention after being assembled;

FIG. 10A is a schematic diagram showing the airflow of the illuminating device of the present invention of FIG. 9B while being in the vertical position;

FIG. 10B is a schematic diagram showing the airflow of the illuminating device of the present invention of FIG. 9B while being in the inverse position; and

FIG. 10C is a schematic diagram showing the airflow of the illuminating device of the present invention of FIG. 9B while being in the horizontal position.

### DETAILED DESCRIPTION OF THE INVENTION

The present invention will be apparent from the following detailed description, which proceeds with reference to the accompanying drawings, wherein the same references relate to the same elements.

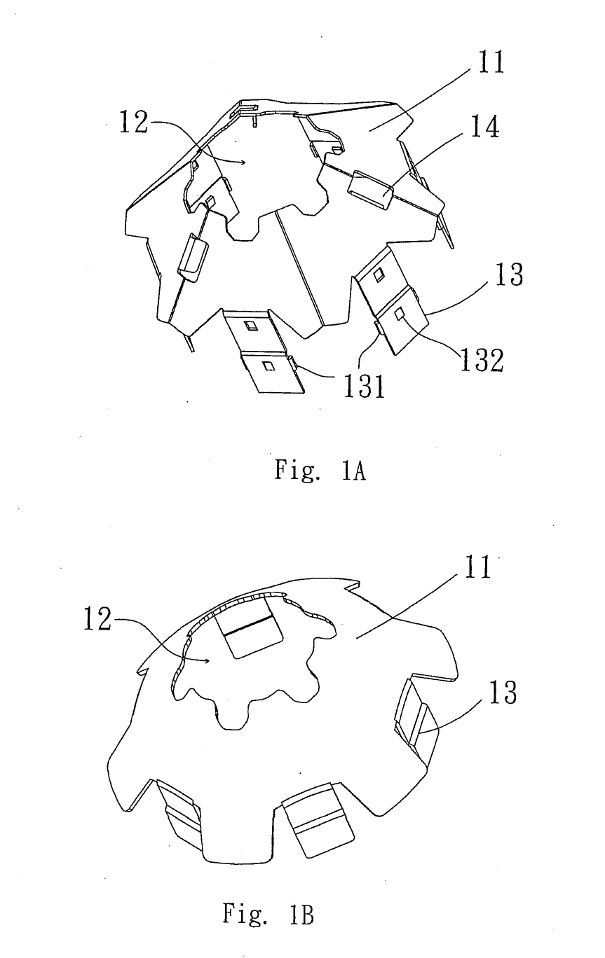

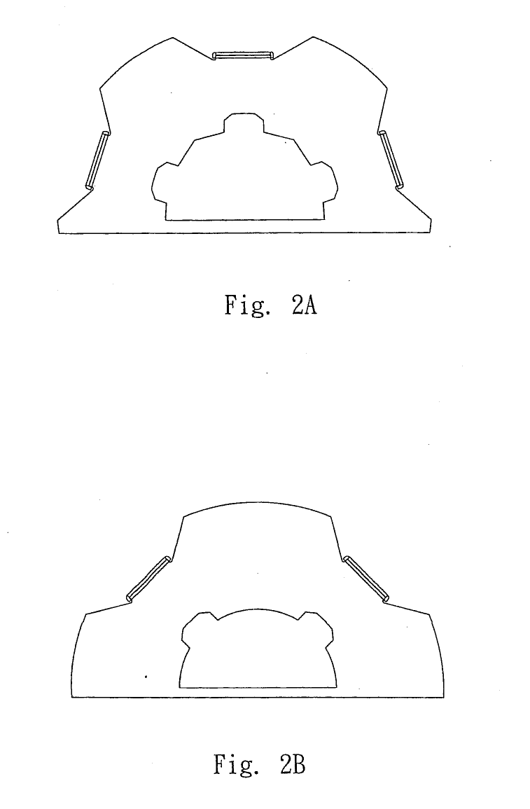

According to the present invention, the heat-dissipating stricture includes one or a plurality of heat-dissipating units stacked together, and the heat-dissipating structure, which is coordinated with a thermal conductive element, can provide multi-directional natural convection. The heat-dissipating unit is preferably formed by metal stamping, and can be made of various material with different thickness to meet the real requirement. The heat-dissipating unit includes a cone-like portion 11 with an opening 12 and a plurality of protrusions 13 connected to the edge of the cone-like portion 11. The heat-dissipating unit can be an umbrella-shaped pyramid structure or conoid structure as shown in FIG. 1A and FIG. 1B. The heat-dissipating unit can be also a cone-like unsymmetrical structure as shown in FIG. 2A and FIG. 2B.

Referring to FIG. 1A, each protrusion 13 of the heat-dissipating unit has two fasteners 131 disposed on its both sides, respectively. The protrusion 13 has a stepped bending portion with a through hole 132 on its surface, and the through hole 132 can accelerate the movement of airflow. Certainly, the fastener 131 and the through hole 132 are optionally used depending on the product demands.

According to the user's requirement, the heat-dissipating unit can be symmetrically or unsymmetrically designed with two bending portions, three bending portions or six bending portions, etc. The bending portion is attached by the thermal conductive element connected with a heat source, for transmitting heat to the cone-like radiating surface. As shown in FIG. 1B, the protrusion 13 of the heat-dissipating unit is a stepped bending portion without through hole.

In addition, the surface of the heat-dissipating unit can be further processed by surface treatment or provided with a microstructure. The microstructure can be formed by a physical or chemical process such as the anodic treatment or coating a material with high heat radiation, for increasing the heat-dissipating area and enhancing heat-radiating effect.

Moreover, the heat-dissipating unit further includes a plurality of apertures 14, as shown in FIG. 1A, for increasing the heat-dissipating area and guiding the airflow to the central opening 12. The cone-like portion 11 can be formed by a plurality of fins as shown in FIG. 1A, or a single annular fin as shown in FIG. 1B.

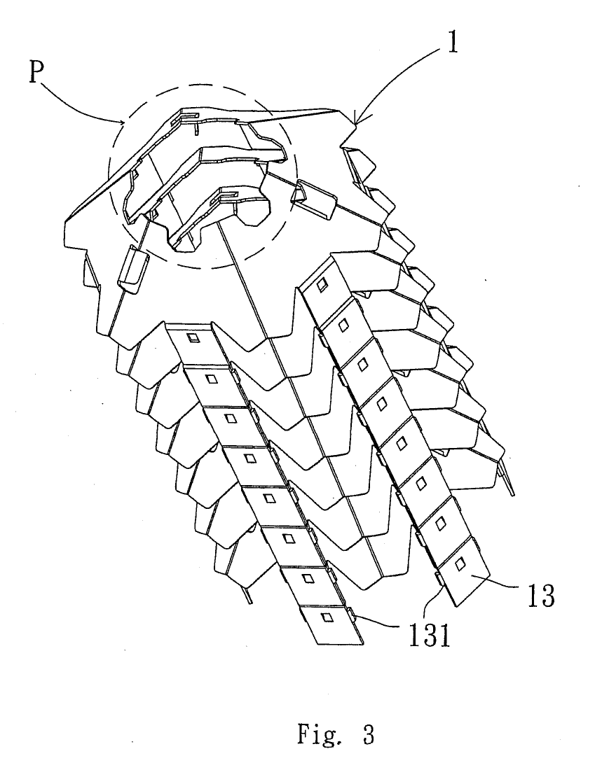

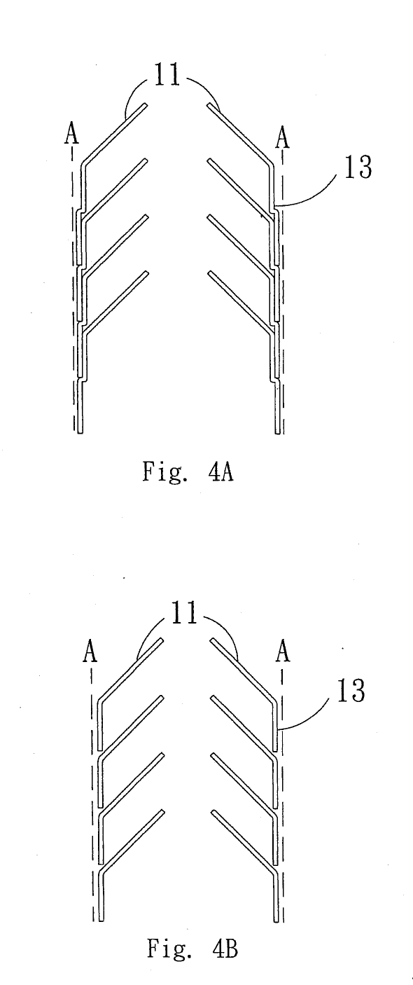

When the heat-dissipating units, as shown in FIG. 1A, are stacked together, the chimney-shaped heat-dissipating structure can be formed as shown in FIG. 3. While the heat-dissipating units are stacked together, the bending portions close to each other and form a plane A as shown in FIG. 4A and FIG. 4B. The plane A allows the thermal conductive element to be disposed thereon, and serves as a medium of the heat transmission. The bending portion can be designed as a bending portion with height difference or a stepped bending portion, and the height difference of one bending portion can receive another bending portion as shown in FIG. 4A. The bending portion can be also a planar bending portion as shown in FIG. 4B. Optionally, the bending portion can be provided with a fastener 131 for positioning and connecting with the adjacent bending portion as shown in FIG. 3. Thus, the plurality of the heat-dissipating units can position and connect to each other while being stacked together.

After assembling the plurality of the heat-dissipating units as shown above, the openings of the plurality of the heat-dissipating units are linked together and form a central airflow passage P as shown in FIG. 3. There is a gap between two adjacent cone-like portions for allowing the airflow to pass therethrough. Therefore, the cold airflow will pass through the surface of the heat-dissipating structure and take heat away. The airflow passage P can accelerate movement of the airflow passing through the cone-like surface of the heat-dissipating unit because of the structural characteristic.

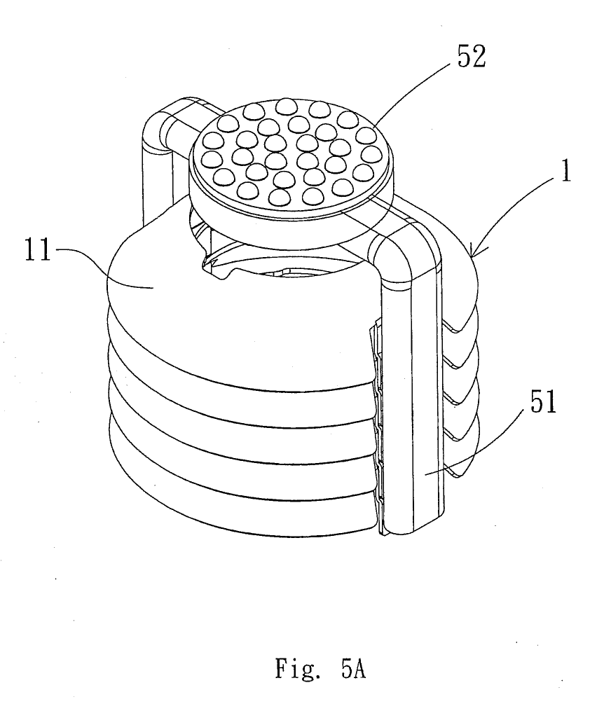

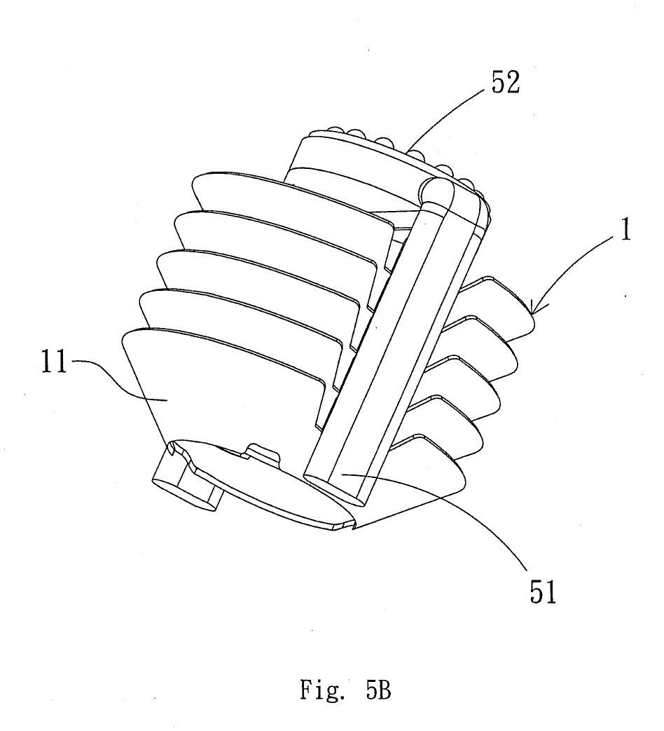

Referring to FIG. 5A and FIG. 5B, an multilayer structure 1 includes a plurality of heat-dissipating units stacked together. While the heat-dissipating units are stacked together, the bending portions close to each other to form a plane. The heat-dissipating unit with N bending portions will form N zonal planes A, and a plurality of thermal conductive elements 51 are disposed on the zonal planes A. The thermal conductive element 51 can be attached by one or more heat sources 52 directly, or connected with the heat source 52 via a carrier. The multilayer structure 1 further includes a protruding end and a concave end, and the heat source 52 is disposed at the protruding end as shown in FIG. 5A or at the concave end as shown in FIG. 5B. The heat source 52 can be a semiconductor light source such as a light emitting diode (LED), a laser diode or an organic light emitting diode (OLED).

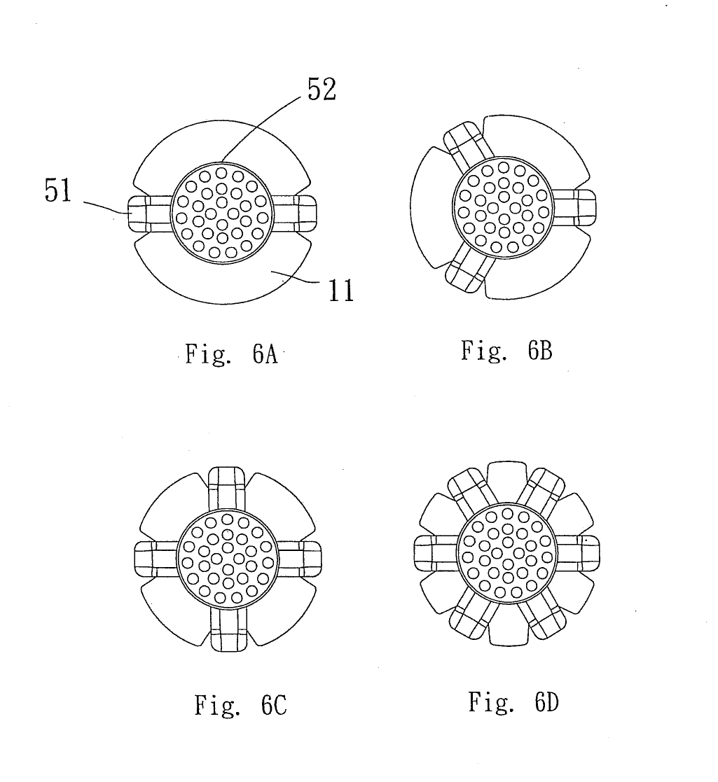

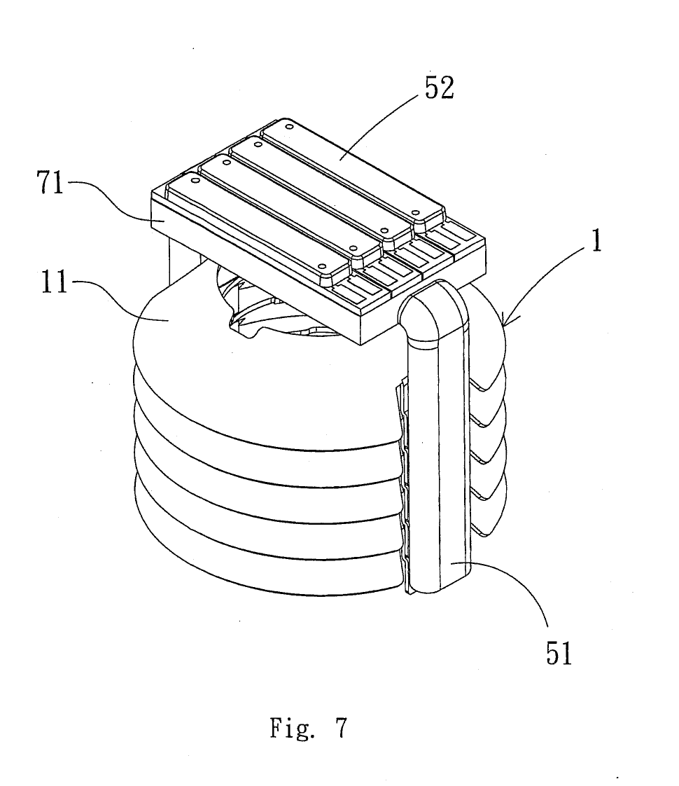

The cross section of the thermal conductive element 51 can be a square, a circle, an ellipse or a rectangle, and the thermal conductive element 51 can be a hollow or non-hollow structure, such as a thermal conductive pipe or bar. The amount of the thermal conductive element 51 is one or more. Please refer to FIG. 6A to FIG. 6B showing different amount of the thermal conductive element of the heat-dissipating structure according to the present invention. The amount of the thermal conductive element 51 depends on the product demand or functional requirement.

Referring to FIG. 7, the heat-dissipating structure of the present invention includes a carrier 71 having a plane for allowing one or more heat sources to be disposed thereon. The thermal conductive element 51 are connected with the carrier 71 and the multilayer structure 1 includes a plurality of heat-dissipating units stacked together. The thermal conductive elements and the carrier are made of a metallic or non-metallic high thermal conductive material so that the heat generated from the heat source can be rapidly transmitted to the heat-dissipating unit, thereby dissipating heat through the cone-like portion.

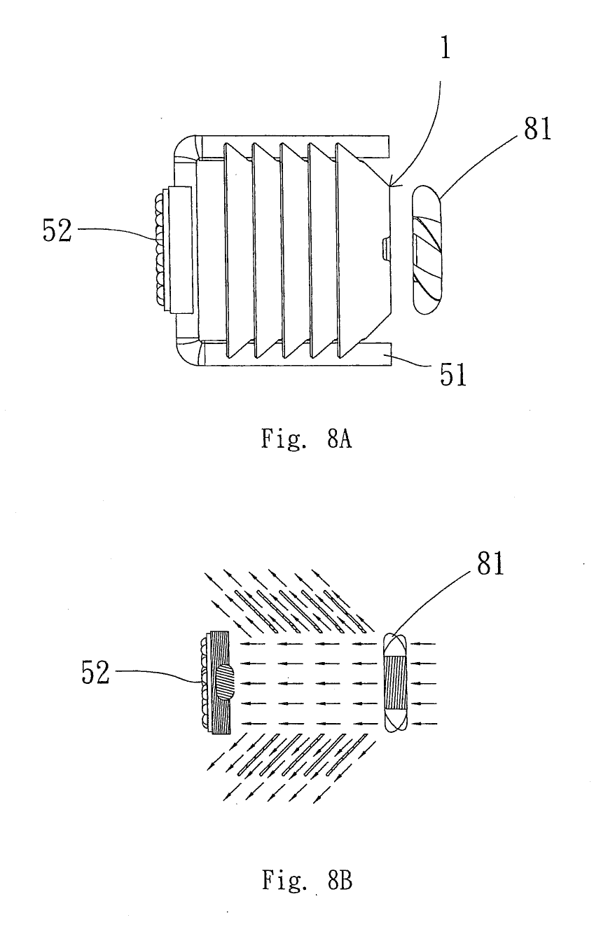

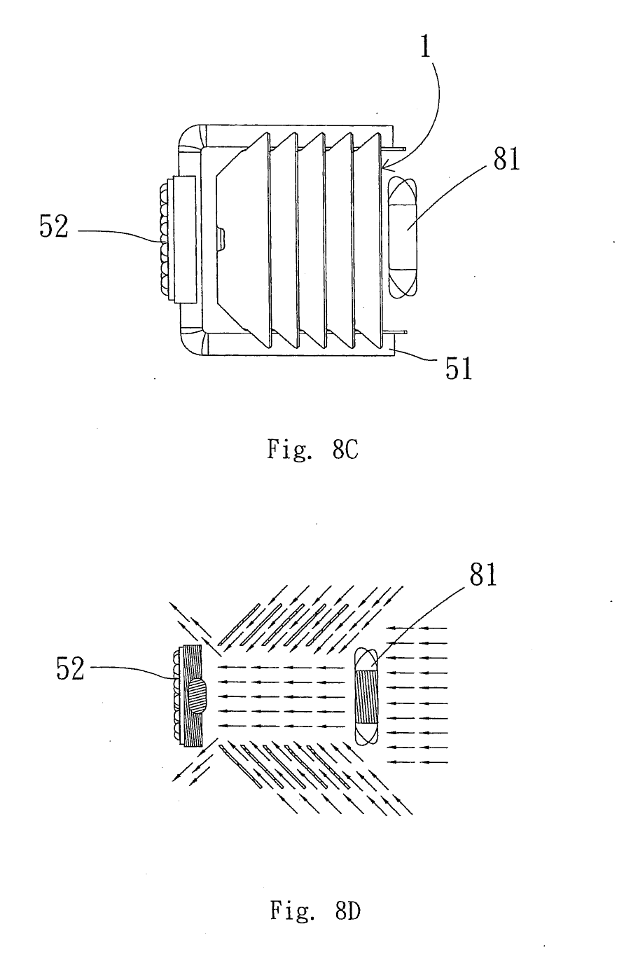

Moreover, the heat-dissipating structure of the present invention further includes a fan as shown in FIG. 8A and FIG. 8B. The heat-dissipating structure includes a multilayer structure 1, a plurality of thermal conductive elements 51 and a fan 81. FIG. 8B is a schematic diagram showing the airflow of the heat-dissipating structure shown in FIG. 8A. The fan 81 and the heat source 52 are respectively disposed at two opposite sides of the multilayer structure 1. When the fan 81 is disposed at the protruding end and the heat source 52 is correspondingly disposed at the concave end, the airflow generated from the fan 81 passes through an airflow passage formed by the openings of the heat-dissipating units linked together so as to dissipate heat generated from the heat source 52. Afterwards, the airflow passes the surface of the cone-like portion and takes heat out from the heat-dissipating structure.

Referring to FIG. 8C and FIG. 8D, the fan 81 is disposed at the concave end of the multilayer structure, and the heat source 52 is disposed at the protruding end. The difference between FIGS. 8C and 8D is that the airflow generated from the fan 51 passing through the airflow passage to dissipate heat generated from the heat source 52, the outer airflow can also enter the central airflow passage to dissipate heat accumulated on the surface of the cone-like portion via the airflow passage.

According to the present invention, the heat-dissipating area of the umbrella like heat-dissipating unit is larger than that of the conventional heat sink. Thus, the heat generated from the heat source can be transmitted to the heat-dissipating unit rapidly by heat conduction, and the multi-directional airflow can be guided by heat convection. The heat is dissipated outside through the airflow convection formed by physical principle of heat airflow moving upward.

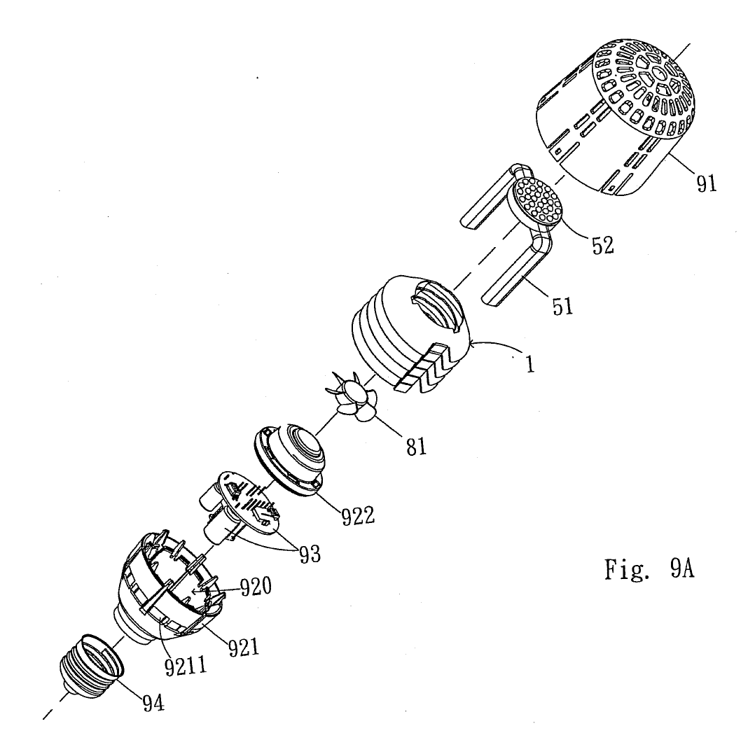

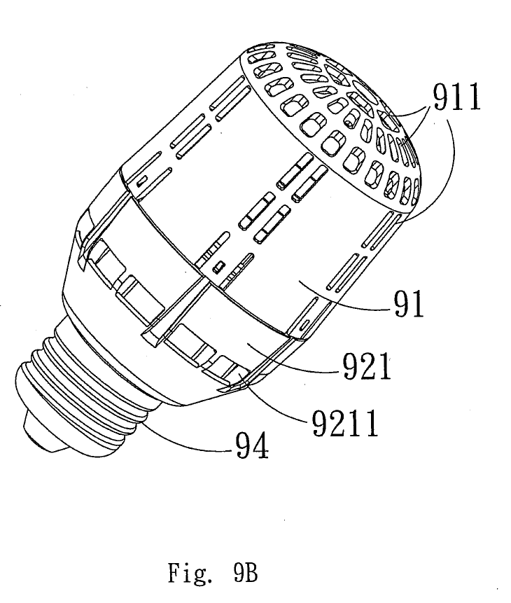

Referring to FIG. 9A and FIG. 9B, an embodiment of the illuminating device according to the present invention includes a thermal conductive element 51, a multilayer structure 1, a fan 81, a heat source 52, a transparent cover 91, a securing structure, an electric component 93 and a power connector 94. The heat source 52 includes one or more illuminating element, and the illuminating element is a light emitting diode (LED), a laser diode, an organic light emitting diode (OLED) or a semiconductor light source. The power connector 94 is E10/E11, E26/E27 or E39/E40. Of course, if the illuminating element is an alternating current LED, the electric component 93 can be omitted. The transparent cover 91 further includes a plurality of vents disposed thereon circumambiently for increasing airflow and decreasing temperature to achieve the effect of cooling the heat-dissipating structure. Certainly, these vents 911 are optionally used depending on the product demands. The securing structure includes a first part 921 and a second part 922, and the electric component 93 can be disposed in a space 920 defined between the first part 921 and the second part 922. The combination of the thermal conductive element 51, the fan 81, the multilayer structure 1 and the heat source 52 can be fixed on the surface of the second part 922 by engagement or other equivalent way. Optionally, a plurality of through holes 9211 can be disposed on the first part 921. In addition, the thermal conductive element can be connected with a carrier having a plane for allowing the heat source to be disposed thereon, and the heat source can be dissipated heat through the carrier.

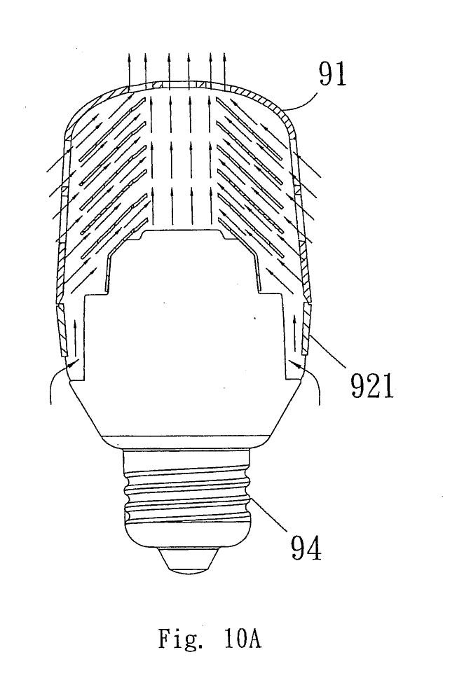

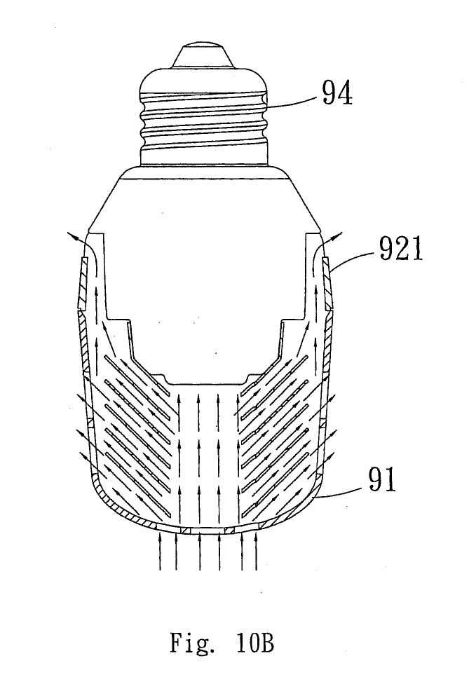

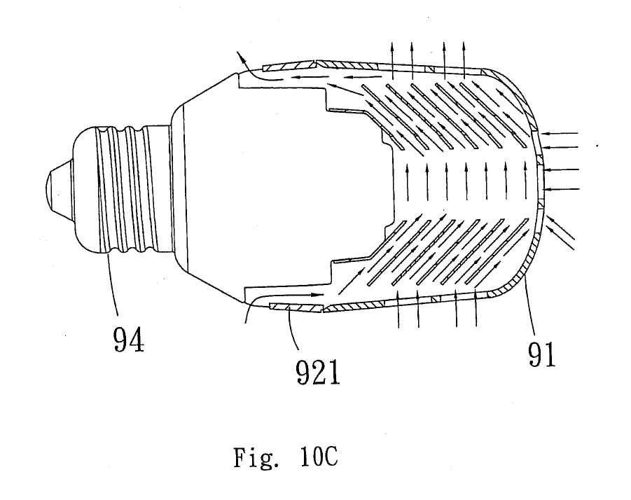

While the illuminating device, as shown in FIG. 9B, is configured in the vertical or inverse position, a chimney effect is formed in the central airflow passage P. The chimney effect is useful to enhance the effect of convection and heat dissipation. Please refer to FIG. 10A showing the illuminating device while being in the vertical position. The cold airflow passes through the vents of the transparent cover 91, the first part 921, and the gaps between the heat-dissipating units, and converges together in the central airflow passage P finally. Thus, the airflow passes through the cone-like surface of the heat-dissipating structure and dissipates heat by the way of heat transmission and heat convection. Please refer to FIG. 10B the illuminating device in the inverse position, and the direction of the airflow is contrary with that of FIG. 10A. Additionally, while the illuminating device is in the horizontal position, the airflow can also pass through the cone-like surface of the heat-dissipating structure successfully. The airflow enters the central airflow passage of the illuminating device from underside vents, and is discharged from upside vents as shown in FIG. 10C. Therefore, the heat-dissipating structure of the illuminating device according to the present invention can be used to dissipate heat in all position.

In conclusion, the illuminating device and the heat-dissipating structure of the present invention provide multi-directional natural convection and can be configured in any position. Thus, the present invention achieves the chimney-like effect to accelerate the dissipation of heat through the central airflow passage. Moreover, the heat-dissipating structure of the present invention is made by stamping thin metals and stacking them together. Compared with the conventional heat sinks, the heat-dissipating structure of the present invention has the advantages of a large increase of heat-dissipating area, a reduction of material usage, and the conservation of energy and cost. Further, the heat-dissipating structure also includes the fan and the thermal conductive element so as to enhance heat-dissipating effect.

Furthermore, the heat-dissipating structure of the present invention includes a plurality of heat-dissipating units stacked together with bending portions. While the heat-dissipating units are stacked together, the multi-side bending portions of adjacent heat-dissipating units close to each other to form a plane for allowing the thermal conductive element to be disposed thereon. The plurality of thermal conductive elements are disposed on the surface of the heat-dissipating structure circumambiently to be connected with the heat source, thereby achieving the heat-dissipating effect of multi-directional convection.

While the invention has been described in connection with what is presently considered to be the most practical and preferred embodiment, it is to be understood that the invention is not limited to the disclosed embodiments, but, on the contrary, is intended to accommodate various modifications and equivalent arrangements included within the spirit and scope of the appended claims.

What is claimed is:

1. A heat-dissipating structure comprising:
at least one thermal conductive element; and
at least one heat-dissipating unit comprising a cone-like portion with an opening, and at least one protrusion connected to the cone-like portion and providing a plane for allowing the thermal conductive element to be disposed thereon, wherein the opening of the heat-dissipating unit is served as an airflow passage.

2. The heat-dissipating structure of claim 1, wherein the thermal conductive element is connected with a heat source.

3. The heat-dissipating structure of claim 2, wherein the heat source is disposed on the thermal conductive element directly, or connected with the thermal conductive element via a carrier having a plane for allowing the heat source to be disposed thereon.

4. The heat-dissipating structure of claim 3, wherein the thermal conductive element and the carrier are made of a metallic or non-metallic high thermal conductive material.

5. The heat-dissipating structure of claim 2, wherein the heat-dissipating units are stacked together to constitute a multilayer structure with a protruding end and a concave end, and the heat source is disposed at the protruding end or the concave end.

6. The heat-dissipating structure of claim 4, further comprising a fan disposed opposite to the heat source for guiding the airflow to the heat source via the airflow passage.

7. The heat-dissipating structure of claim 1, wherein the thermal conductive element has a square, a circle, an ellipse or a rectangle cross section, and the thermal conductive element is a hollow or non-hollow structure.

8. The heat-dissipating structure of claim 1, wherein the thermal conductive element is a thermal conductive pipe or a thermal conductive bar.

9. The heat-dissipating structure of claim 1, wherein the heat-dissipating unit is formed by metal stamping, and the heat-dissipating unit is a pyramid, a conoid, or an umbrella-shaped unsymmetrical structure.

10. The heat-dissipating structure of claim 1, wherein the protrusion has a fastener for positioning and connecting with the adjacent protrusion.

11. The heat-dissipating structure of claim 1, wherein the protrusion has a planar or stepped bending portion.

12. The heat-dissipating structure of claim 1, wherein the surface of the protrusion has a through hole for accelerating movement of the airflow.

13. The heat-dissipating structure of claim 1, wherein the protrusions are symmetrically or unsymmetrically disposed on the edge of the cone-like portion.

14. The heat-dissipating structure of claim 1, wherein the surface of the heat-dissipating unit is processed physically or chemically for accelerating heat-radiation, processed with anodic treatment, or coated with a high heat-radiating material, or has a microstructure.

15. The heat-dissipating structure of claim 1, wherein the heat-dissipating unit further includes a plurality of apertures.

16. The heat-dissipating structure of claim 1, wherein the cone-like portion is formed by a plurality of fins or a single annular fin.

17. The heat-dissipating structure of claim 1, wherein there is a gap between two adjacent cone-like portions for allowing the airflow to pass therethrough.

18. An illuminating device comprising:
a thermal conductive element;
one or more heat-dissipating units stacked together, each of which comprises a cone-like portion with an opening; and a protrusion connected to the cone-like portion and providing a plane for allowing the thermal conductive element to be disposed thereon; and
a heat source connected with the thermal conductive element.

19. The illuminating device of claim 18, wherein the heat source is disposed on the thermal conductive element directly, or connected with the thermal conductive element via a carrier having a plane for allowing the heat source to be disposed thereon.

20. The illuminating device of claim 19, wherein the thermal conductive element and the carrier are made of a metallic or non-metallic high thermal conductive material.

21. The illuminating device of claim 18, wherein the thermal conductive element is a thermal conductive pipe or a thermal conductive bar.

22. The illuminating device of claim 18, further comprising a fan disposed opposite to the heat source for guiding the airflow to the heat source via the airflow passage.

23. The illuminating device of claim 18, further comprising a housing disposed outside the heat-dissipating structure and the light source.

24. The illuminating device of claim 18, further comprising a securing structure used to fasten the heat-dissipating units, wherein the securing structure comprises a first part and a second part, and the illuminating device further comprises an electric component disposed in a space formed between the first part and the second part of the securing structure.

25. The illuminating device of claim 18, further comprising a power connector, and the type of the power connector is E10/E11, E26/E27 or E39/E40.
